(19) United States
(12) Patent Application Publication
(10) Pub. No.: US 2018/0329490 A1
(43) Pub. Date: Nov. 15, 2018

(54) VIRTUAL REALITY SYSTEM SIMULATING SENSING SIGNAL OF PORTABLE DEVICE AND CONTROLLING METHOD THEREOF

(71) Applicant: Acer Incorporated, New Taipei City (TW)

(72) Inventor: Chao-Kuang Yang, New Taipei City (TW)

(21) Appl. No.: 15/712,440

(22) Filed: Sep. 22, 2017

(30) Foreign Application Priority Data
May 12, 2017 (TW) 106115717

(51) Int. Cl. G06F 3/01; H04W 4/00; G02B 27/01; G06F 13/10

(52) U.S. Cl. CPC G06F 3/013; G06F 13/102; G02B 27/017; H04W 4/008

(57) ABSTRACT

A virtual reality system having automatic discovering and connecting function and a controlling method thereof are provided. The controlling method of the virtual reality system includes the following steps: An identification signal is broadcasted by a head-mounted display device. The identification signal is received by a portable device. A communication path between the portable device and the head-mounted display device is built according to the identification signal.

This application claims the benefit of Taiwan application Serial No. 106115717, filed May 12, 2017, the disclosure of which is incorporated by reference herein in its entirety.

### TECHNICAL FIELD

The disclosure relates in general to a virtual reality system and a controlling method thereof, and more particularly to a virtual reality system having automatic discovering and connecting function and a controlling method thereof.

### BACKGROUND

Along with the development of virtual reality (VR) technology, various software and hardware products of virtual reality are invented. The virtual reality technology generates a 3D virtual world through computer simulation, which simulates user's visual faculty and provides a sense of immediacy to the user.

When the user moves or rotates, the computer immediately performs complicated computation and feeds back an accurate 3D image which provides a sense of immediacy to the user. The virtual reality technology integrates computer simulation, sensing, displaying, computer graphics, and artificial intelligence, and has become a new focus of technology.

However, when the user wears the head-mounted display device, the user will be isolated from the external environment to a certain degree. Meanwhile, when the user's mobile phone has an incoming call or the instant messaging software receives a message, the user may not be immediately informed of the incoming call or message. If the incoming call or message is very important but the user missed it, a severe loss may occur.

### SUMMARY

The disclosure is directed to a virtual reality system and a controlling method thereof capable of automatically building a communication path with the portable device. Even when the user wears the head-mounted display device and is isolated from the external environment to a certain degree, the communication path between the head-mounted display device and the user's the portable device still can be automatically built. When the portable device receives an incoming call or the instant messaging software receives a message, the user will be immediately informed of the incoming call or message, and will not miss any important incoming calls or any important messages.

According to one embodiment, a controlling method of a virtual reality system is provided. The controlling method of the virtual reality system includes the following steps: An identification signal is broadcasted by a head-mounted display device. The identification signal is received by a portable device. A communication path between the portable device and the head-mounted display device is built according to the identification signal.

According to another embodiment, a virtual reality system is provided. The virtual reality system includes a head-mounted display device and a portable device. The head-mounted display device broadcasts an identification signal. The portable device receives the identification signal, and builds a communication path between the portable device and the head-mounted display device according to the identification signal.

According to another embodiment, a head-mounted display device is provided. The head-mounted display device includes a broadcasting unit and a transmitting unit. The broadcasting unit broadcasts an identification signal, such that a portable device receives the identification signal. The portable device builds a communication path between the portable device and the transmitting unit of the head-mounted display device according to the identification signal.

According to another embodiment, a portable device is provided. The portable device includes a transmitting unit and a path establishing unit. The transmitting unit receives an identification signal broadcasted by a head-mounted display device. The path establishing unit builds a communication path between the transmitting unit and the head-mounted display device according to the identification signal.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a block diagram of a virtual reality system according to an embodiment of the invention.

FIG. 2 is a flowchart of a controlling method of the virtual reality system according to an embodiment of the invention.

FIG. 3 is a block diagram of a virtual reality system according to another embodiment of the invention.

FIG. 4 is a flowchart of a controlling method of the virtual reality system according to another embodiment of the invention.

### DETAILED DESCRIPTION

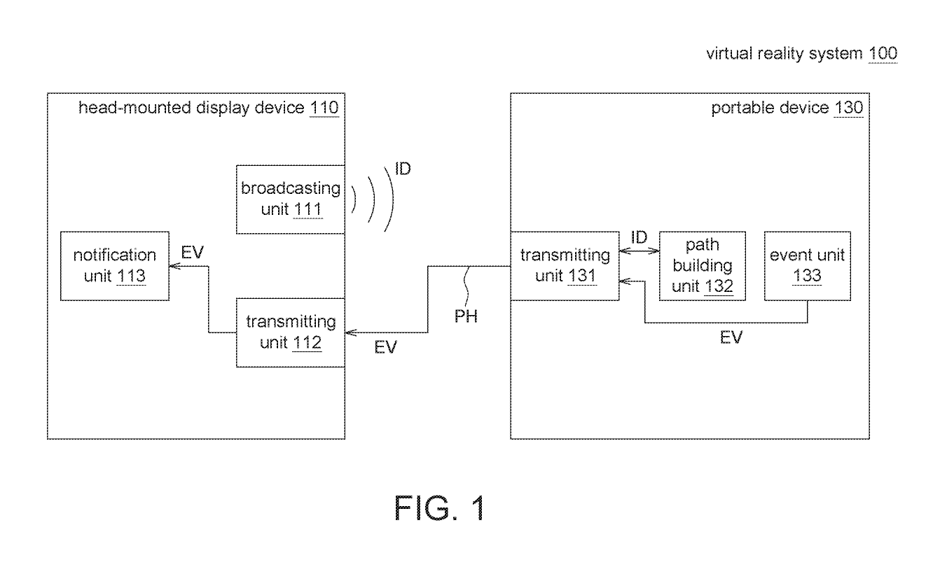

Referring to FIG. 1, a block diagram of a virtual reality system 100 according to an embodiment of the invention is shown. As illustrated in FIG. 1, the virtual reality system 100 includes a head-mounted display device 110 and a portable device 130. The head-mounted display device 110 can be realized by such as an eye mask, a helmet, or a pair of glasses. The portable device 130 can be realized by such as a smart phone, a tablet computer, or a notebook computer.

The head-mounted display device 110 includes a broadcasting unit 111, a transmitting unit 112 and a notification unit 113. The portable device 130 includes a transmitting unit 131, a path establishing unit 132 and an event unit 133. The broadcasting unit 111 broadcasts various messages. The broadcasting unit 111 can be realized by such as a light emitter, a radio wave transmitter, an audio broadcaster, a recognizable identification code (ID) (such as QR Code, bar code), or a passive read signal source (such as NFC tag). The transmitting units 112 and 131 perform signals transmission. The transmitting unit 112 can be realized by such as a wireless transmission module or a wired transmission module. The notification unit 113 sends a notification message. The notification unit 113 can be realized by such as a display or an audio broadcaster (using ultrasound so not noticeable by human or life forms). The path establishing unit 132 builds a communication path between the transmitting unit 112 and the transmitting unit 131. The event unit 133 generates an event. The event unit 133 can be realized by such as a telephone module, a network communication module, or a power management module. The event can be such as an incoming call, a message of a communication software, or a power warning.

In the present embodiment, the head-mounted display device 110 and the portable device 130 build a communication path PH according to an identification signal ID broadcasted by the broadcasting unit 111, such that the event message EV of the event unit 133 can be transmitted to the notification unit 113 via the communication path PH and the notification unit 113 can notify the user accordingly.

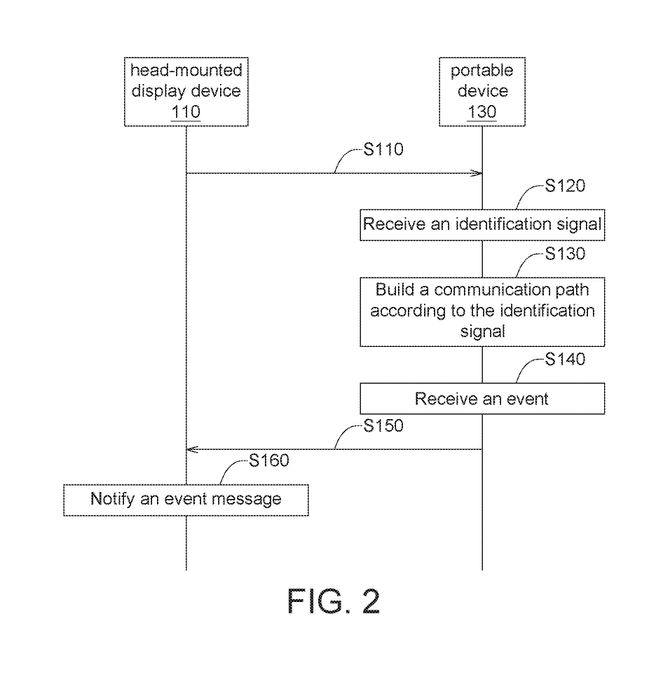

The operations of the above elements are described below with accompanying drawings. Referring to FIG. 2, a flowchart of a controlling method of the virtual reality system 100 according to an embodiment of the invention is shown.

Firstly, the method begins at step S110, an identification signal ID is broadcasted by the broadcasting unit 111 of the head-mounted display device 110. In the present step, the head-mounted display device 110 does not transmit the identification signal ID to a specific recipient, but broadcasts the identification signal ID to arbitrary recipients. Any electronic devices within the range of signal intensity can receive the identification signal ID. The identification signal ID can be realized by such as an optical signal, a radio wave signal, or an audio signal with beacon or quick response code (QR code).

Then, the method proceeds to step S120, the identification signal ID is received by the transmitting unit 131 of the portable device 130. The transmitting unit 131 and the broadcasting unit 111 can belong to the same type of the communication modules, or the broadcasting unit 111 is within the coverage of the transmitting unit 131.

After that, the method proceeds to step S130, a communication path PH between the portable device 130 and the head-mounted display device 110 is built by the portable device 130 according to the identification signal ID. From now, the portable device 130 can transmit the received event to the notification unit 113 (the process is described in paragraphs 0022 to 0024).

Then, the method proceeds to step S140, an event is received by the event unit 133 of the portable device 130.

After that, the method proceeds to step S150, the event message EV is transmitted to the transmitting unit 112 of the head-mounted display device 110 via the communication path PH by the transmitting unit 131 of the portable device 130.

Then, the method proceeds to step S160, the event message EV is notified by the notification unit 113 of the head-mounted display device 110. In an embodiment, the head-mounted display device 110 may display the event message EV using a text or a pattern or explain the event message EV using a voice.

Thus, when the user wears the head-mounted display device 110, the user still can normally receive the event message EV of the portable device 130. The user will not miss any important messages and will not result in severe loss. Or once the notification path is established, the preference settings stored on the portable device, which usually accompanies the user, can be transmitted to the head-mounted display device for hardware characteristic adjustment (preferred IPD, gamma, etc.) accordingly.

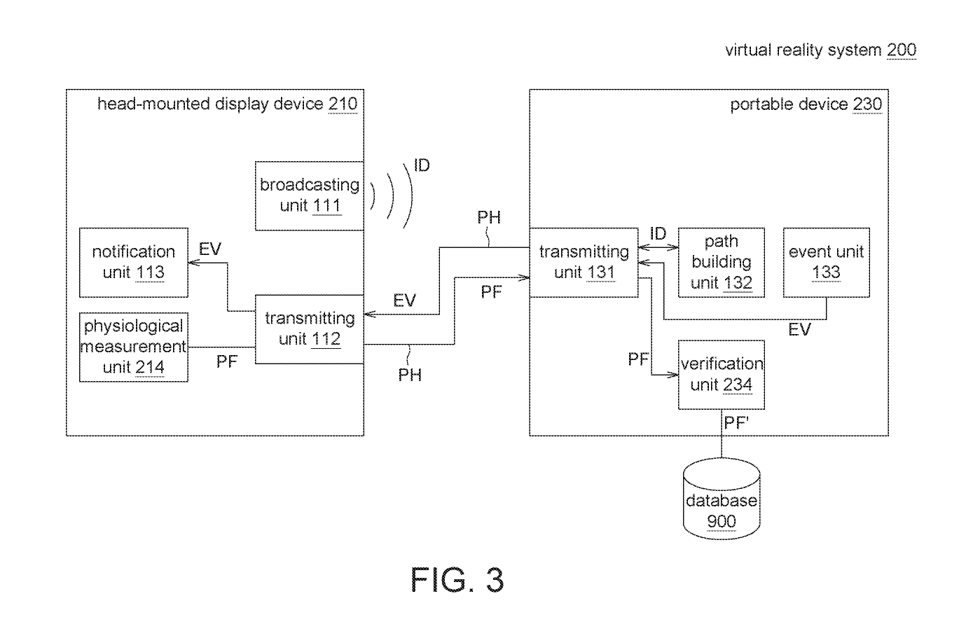

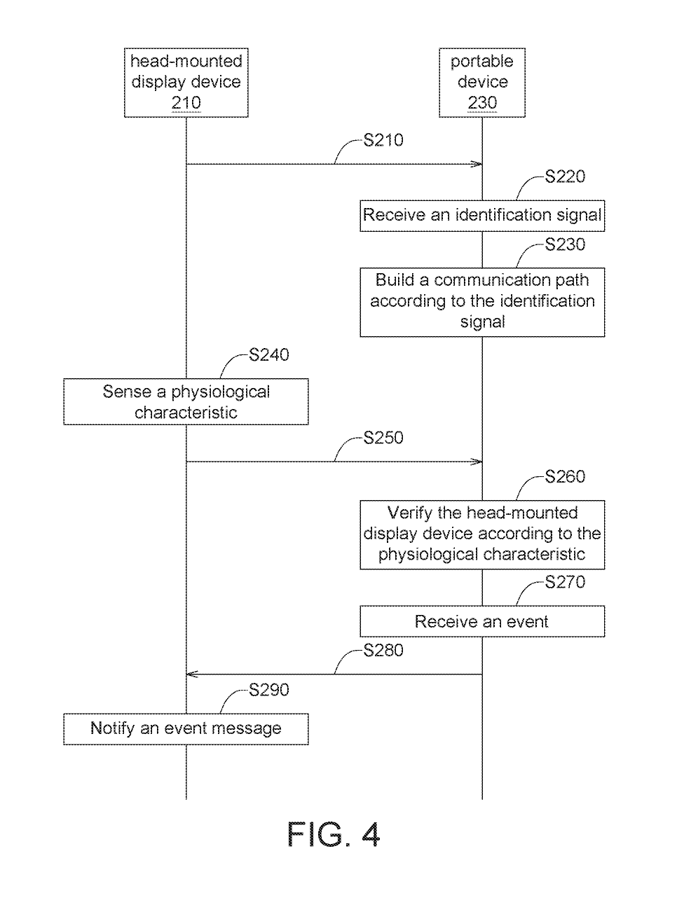

Refer to FIG. 3 and FIG. 4. FIG. 3 is a block diagram of a virtual reality system 200 according to another embodiment of the invention. FIG. 4 is a flowchart of a controlling method of the virtual reality system 200 according to another embodiment of the invention. In the present embodiment, the head-mounted display device 210 further includes a physiological measurement unit 214. The portable device 230 further includes a verification unit 234. The physiological measurement unit 214 senses a physiological characteristic PF of a user. The physiological characteristic PF can be realized by such as an iris pattern or an iris color. The physiological measurement unit 214 can be realized by such as an iris camera. The physiological characteristic PF can be used for verifying the user's identification. After the user's identification successfully passes verification, the event message EV can be notified safely. The physiological measurement unit 214 can measure other physiological characteristics, such as a fingerprint or a voiceprint.

In step S210 as illustrated in FIG. 4, the identification signal ID is broadcasted by the broadcasting unit 111 of the head-mounted display device 210.

Then, the method proceeds to step S220, the identification signal ID is received by the transmitting unit 131 of the portable device 230.

After that, the method proceeds to step S230, a communication path PH between the portable device 230 and the head-mounted display device 210 is built by the portable device 230 according to the identification signal ID.

In step S240, the physiological characteristic PF of the user is sensed by the physiological measurement unit 214 of the head-mounted display device 210.

Then, the method proceeds to step S250, the physiological characteristic PF is transmitted to the portable device 230 by the head-mounted display device 210.

After that, the method proceeds to step S260, the head-mounted display device 210 is verified by the verification unit 234 of the portable device 230 according to the physiological characteristic PF. In the present step, the verification unit 234 accesses a pre-stored physiological characteristic PF′ from a database 900, and further compares the accessed physiological characteristic PF′ with the physiological characteristic PF to check whether the head-mounted display device 210 successfully passes verification.

If the head-mounted display device 210 successfully passes verification, then the method proceeds to step S270, and an event is received by the event unit 133 of the portable device 130.

After that, the method proceeds to step S280, the event message EV is transmitted to the transmitting unit 112 of the head-mounted display device 110 via the communication path PH by the transmitting unit 131 of the portable device 130.

Then, the method proceeds to step S290, the event message EV is notified by the notification unit 113 of the head-mounted display device 110.

In the present embodiment, the safety of the notification procedure of the event message EV is assured through the verification procedure of the user's identification.

The physiological characteristic PF of step S240 can be transmitted when step S210 is performed, such that the connection setting can be simplified. However, the size of the data volume of the physiological characteristic PF depends on whether the physiological characteristic PF can be transmitted in step S210. According to above embodiments, even when the user wears the head-mounted display device and is isolated from the external environment to a certain degree, the communication path between the head-mounted display device and the user's the portable device still can be automatically built. When the portable device receives an incoming call or the instant messaging software receives a message, the user will be immediately informed the incoming call or message, and will not miss any important incoming calls or any important messages. In the application where many head-mounted display devices 110 are used (such as the VR experience zone), the user can choose to connect the portable device 230 using anyone of the head-mounted display devices 110.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A controlling method of a virtual reality system, comprising:
broadcasting an identification signal by a head-mounted display device;
receiving the identification signal by a portable device; and
building a communication path between the portable device and the head-mounted display device according to the identification signal.

2. The controlling method of the virtual reality system according to claim 1, wherein the identification signal is an optical signal, a radio wave signal, or an audio signal.

3. The controlling method of the virtual reality system according to claim 1, further comprising:
sensing a physiological characteristic of a user by the head-mounted display device;
transmitting the physiological characteristic to the portable device by the head-mounted display device; and
verifying the head-mounted display device by the portable device according to the physiological characteristic.

4. The controlling method of the virtual reality system according to claim 3, wherein the physiological characteristic is an iris pattern, or an iris color.

5. The controlling method of the virtual reality system according to claim 1, further comprising:
transmitting an event message to the head-mounted display device via the communication path by the portable device if the portable device receives an event; and
notifying the event message by the head-mounted display device.

6. The controlling method of the virtual reality system according to claim 5, wherein the event is an incoming call, a message of a communication software, or a power warning.

7. The controlling method of the virtual reality system according to claim 5, wherein the head-mounted display device displays the event message using a text or a pattern or explains the event message using a voice.

8. A virtual reality system, comprising:
a head-mounted display device for broadcasting an identification signal; and
a portable device for receiving the identification signal, and building a communication path between the portable device and the head-mounted display device according to the identification signal.

9. The virtual reality system according to claim 8, wherein the identification signal is an optical signal, a radio wave signal, or an audio signal.

10. The virtual reality system according to claim 8, wherein the head-mounted display device senses a physiological characteristic of a user and transmits the physiological characteristic to the portable device, and the portable device further verifies the head-mounted display device according to the physiological characteristic.

11. The virtual reality system according to claim 10, wherein the physiological characteristic is an iris pattern, or an iris color.

12. The virtual reality system according to claim 8, wherein when the portable device receives an event, the portable device further transmits an event message to the head-mounted display device via the communication path, and the head-mounted display device further notifies the event message.

13. The virtual reality system according to claim 12, wherein the event is an incoming call, a message of a communication software, or a power warning.

14. The virtual reality system according to claim 12, wherein the head-mounted display device displays the event message using a text or a pattern or explains the event message using a voice.

15. A head-mounted display device, comprising:
a broadcasting unit for broadcasting an identification signal, such that a portable device receives the identification signal; and
a transmitting unit, wherein the portable device builds a communication path between the portable device and the transmitting unit of the head-mounted display device according to the identification signal.

16. The head-mounted display device according to claim 15, wherein the broadcasting unit is a light emitter, a radio wave transmitter or an audio broadcaster.

17. The head-mounted display device according to claim 15, further comprising:
a physiological measurement unit for sensing a physiological characteristic of a user;
wherein the transmitting unit further transmits the physiological characteristic to the portable device, such that the portable device verifies the head-mounted display device according to the physiological characteristic.

18. The head-mounted display device according to claim 17, wherein the physiological characteristic is an iris pattern, or an iris color.

19. The head-mounted display device according to claim 15, further comprising:
a notification unit for notifying an event message when the transmitting unit receives the event message transmitted by the portable device.

20. The head-mounted display device according to claim 19, wherein the notification unit is a display or a speaker, and the notification unit displays the event message using a text or a pattern or explains the event message using a voice.

21. A portable device, comprising:
a transmitting unit for receiving an identification signal broadcasted by a head-mounted display device; and
a path establishing unit for building a communication path between the transmitting unit and the head-mounted display device according to the identification signal.

22. The portable device according to claim 21, wherein the transmitting unit further receives a physiological characteristic of a user sensed by the head-mounted display device, and the portable device further comprises:
a verification unit for verifying the head-mounted display device according to the physiological characteristic.

23. The portable device according to claim 22, wherein the physiological characteristic is an iris pattern, or an iris color.

24. The portable device according to claim 22, further comprising:
an event unit for receiving an event;
wherein when the transmitting unit receives the event, the transmitting unit further transmits an event message to the head-mounted display device via the communication path, such that the head-mounted display device notifies the event message.

25. The portable device according to claim 24, wherein the event is an incoming call, a message of a communication software, or a power warning.
